(19) United States
(12) Patent Application Publication
(10) Pub. No.: US 2014/0015244 A1
(43) Pub. Date: Jan. 16, 2014

(54) Sanitary Fitting

(71) Applicant: Hangsgrohe SE, Schiltach (DE)

(72) Inventors: Bernd Kronenbitter, Nordrach (DE); Jürgen Schorer, Schiltach (DE)

(73) Assignee: Hansgrohe SE, Schiltach (DE)

(21) Appl. No.: 13/939,509

(22) Filed: Jul. 11, 2013

(30) Foreign Application Priority Data
Jul. 13, 2012 (DE) 10 2012 212 306.7

(51) Int. Cl. F16L 41/02

(52) U.S. Cl. CPC F16L 41/02
USPC 285/125.1

(57) ABSTRACT

A sanitary fitting contains a fitting housing with a basic element in the form of a straight circular cylinder with an open underside. An interior with a straight-line central axis is formed inside the basic element, into which and out of which lines pass through the open underside. The basic element has a branch which likewise has the form of a circular cylinder with an open outer face. The interior of the branch merges into the interior of the basic element. The branch contains a receptacle for a mixer cartridge. A connecting element inserted in the branch is used to make the water-carrying connection between the lines inside the basic element and the mixer cartridge inside the branch. The connecting element consists of plastic.

The invention relates to a sanitary fitting having a fitting housing and a housing section containing a receptacle for accommodating a mixer cartridge. Sanitary fittings of this type have for example a fitting housing with a cylindrical basic form fastened to a flat surface. Inside the fitting housing, an interior open towards the flat fastening surface is provided, into which are routed at least the supply lines to the mixer cartridge. A line leading away from the mixer cartridge can also lead out through the interior and through the open end face. Fitting housings of this type are also referred to as single-hole mixers.

### SUMMARY

The object underlying the invention is to design a sanitary fitting having a fitting housing such that it can be assembled out of its individual parts without problem even in cramped space conditions.

To attain this object, the invention proposes a sanitary fitting having the features set forth in Claim 1. Further embodiments of the invention are the subject-matter of sub-claims.

The connecting element mentioned in Claim 1 is used to make the connection between the supply lines and the mixer cartridge. It is inserted from that side from which the mixer cartridge too is later inserted. The connecting element has a possibility for connecting the supply lines inside its part projecting into the interior of the fitting housing. The supply lines can therefore be connected to the connecting element for example after insertion of the latter.

In a development of the invention, it can be provided that the connecting element is not only inserted into the fitting housing through the housing section having the receptacle for the mixer cartridge, but also fixed or fastened in this housing section. This can for example be achieved in that an at least partially formed shoulder is provided as a contact surface inside the housing section, at which a correspondingly shaped abutting shoulder comes into contact with the connecting element. This fixes the connecting element in its position. The actual fastening can then be achieved by fastening the mixer cartridge inside its receptacle. This simplifies the assembly and fixing of the individual parts of the sanitary fitting.

It can be provided in a development in accordance with the invention that the abutting shoulder is formed at that end of the connecting element associated with the mixer cartridge. The connecting element can be kept short in this way, so that only a small amount of space is needed.

In a further development of the invention, it can be provided that the mixer cartridge directly contacts the connecting element, so that the connecting element takes on the role of the housing bottom for the bottom of the mixer cartridge. This too is a measure taken to achieve a low design length of the housing section with the receptacle for the mixer cartridge.

The housing section with the receptacle for the mixer cartridge can be a bend of a pipe-like fitting housing, but also and in particular it can, as proposed by the invention, be a branch of the fitting housing. The fitting housing can for example have the form of a straight cylinder with a branch for the mixer cartridge. That part of the fitting housing continued in a straight line is then available for other purposes.

The branch can here be at right angles, i.e. at an angle of 90°, relative to a longitudinal axis of the remaining part of the fitting housing, but it can also be at an oblique angle. The oblique angle is greater than 0° and less than 90° and is preferably between 45° and 85°, more preferably between 70° and 85°. This differing arrangement of the mixer cartridge in respect of the supply lines can be compensated for by an appropriate design of the connecting element.

In particular, it can be provided that the separation surface of the connecting element associated with the mixer cartridge is parallel to the longitudinal axis of the fitting housing. This design then takes effect in particular when the branch with the receptacle for the mixer cartridge is at right angles to the longitudinal axis of the fitting housing.

When the branch is at an oblique angle, it is useful for the separation surface of the connecting element associated with the mixer cartridge to be oblique to the longitudinal axis of the fitting housing, preferably such that it is arranged vertically to the longitudinal axis of the receptacle for the mixer cartridge.

For connection of the supply lines to the connecting element, and if necessary of a line leading away from the mixer cartridge in the area of that part of the connecting element projecting into the interior of the fitting housing, the connecting element can have plug-in couplings, in particular when the supply lines and/or the discharging line supplied by the mixer cartridge with water are designed as hoses.

It has been mentioned that the connecting element projects so far into the interior that the lines can be connected to the part arranged inside the interior. Since the connecting element is preferably fastened in the housing section containing the receptacle for the mixer cartridge, it is possible that the part projecting into the interior is at a distance from the opposite wall of the interior. This distance can be selected such that a further line can be passed through there and then for example leads out of the upper end of the fitting housing.

To insert the connecting element into the housing section in the correct position, an alignment aid can be provided in a development in accordance with the invention and is effective between the fitting housing and the connecting element.

An alignment aid of this type can also be provided between the connecting element and the mixer cartridge.

It can be provided in a development in accordance with the invention that the connecting element consists overall of a material approved for drinking water or food, in particular a plastic harmless in respect of foodstuff safety.

In this way, it can be assured that the water does not come into contact with metal at any point inside the sanitary fitting.

In an advantageous development of the invention, the connecting element has one plug-in coupling for a discharging line and at least two plug-in couplings for supply lines, where the plug-in coupling for the discharging line is arranged closer towards the side of the mixer cartridge than the plug-in couplings for the supply lines. This structural measure has for example the advantage that a corresponding supply line hose does not have to be so sharply curved when it is continued past the connecting element through a corresponding free space in the interior of the fitting housing, with the direction reversed from down to up.

Further features, details and advantages of the invention are shown in the claims and in the abstract, the wordings of both of which are made into the substance of the description by reference, in the following description of preferred embodiments of the invention, and by the drawing.

### BRIEF DESCRIPTION OF THE DRAWINGS

The drawings show in:

FIG. 1 a perspective view of the individual parts of a sanitary fitting according to the invention;

FIG. 2 a section through the fitting in FIG. 1 in the assembled state;

FIG. 3 a view corresponding to FIG. 1 in a sanitary fitting having an obliquely angled receptacle for the mixer cartridge;

FIG. 4 a section corresponding to FIG. 2 through the sanitary fitting of FIG. 3.

### DETAILED DESCRIPTION

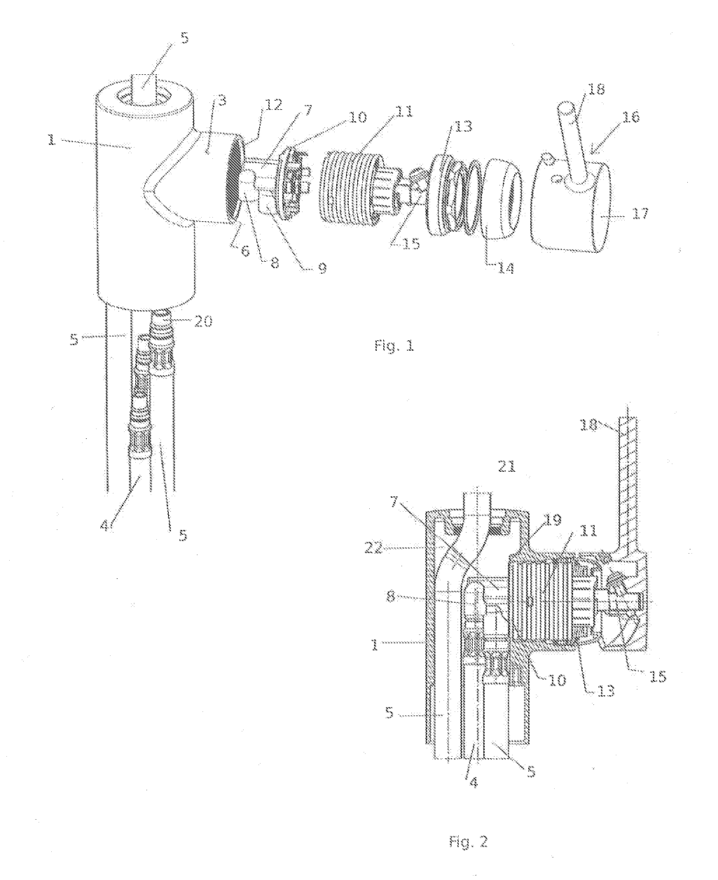

FIG. 1 shows on the left the fitting housing 1 which has the form of a straight circular cylinder with a flat underside and a flat upper side 2. The fitting housing 1 has a housing section 3 forming a branch. The branch 3 likewise has the shape of a straight circular cylinder. The branch is vertical to the longitudinal axis of the fitting housing 1.

Supply lines 4 can pass through the open underside of the fitting housing 1 into the interior of the fitting housing, as can a line 5 leading away from it which forms a loop and is then passed as a line 5 through the fitting housing 1 upwards and out of the latter.

The housing section 3 has an end face open in one plane. A connecting element 7 is intended for insertion through this open end face 6 and has in its left-hand area in FIG. 1 plug-in connections 8, 9 for the supply lines 4 and the discharging line 5. At its end shown on the right in FIG. 1, the connecting element is designed as a plate element 10 whose outer diameter approximately corresponds to the internal diameter of the housing section 3.

This plate element 10 is designed for interaction with a mixer cartridge 11 which contains the mixing system proper and is likewise intended and designed for insertion into the housing section 3 forming a receptacle 12. A clamping nut 13 is intended for fastening the mixer cartridge 11 in the receptacle 12, and then a rosette 14 covers it. The actuating lever 15 projecting out of the mixer cartridge 11 also projects through the rosette 14. An actuating handle 16 is screwed onto the lever, covers the actuating device with a cap 17 and is provided with a projecting lever 18. A user can grip the lever 18 to actuate the mixer cartridge 11.

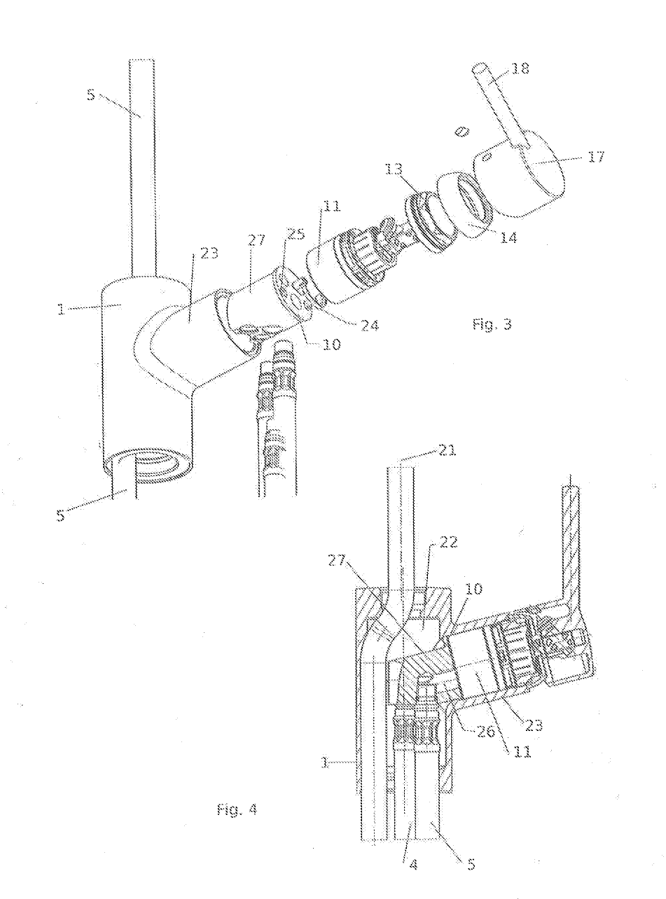

As can be seen from FIGS. 1 and 2 and from the view in FIG. 3 for the variant therein, the two plug-in connections 8 for the supply lines 4 are arranged in a transverse plane next to one another, and the plug-in connection 9 for the discharging line 5 is arranged in front of this transverse plane closer towards the side of the mixer cartridge 11. The plug-in connection 9 for the discharging line 5 is thus arranged on that side of the plug-in connections 8 for the supply lines which is opposite the interior 22 of the fitting housing 1. This allows the curvature for the discharging hose line 5, at its lower reversing end from which it is routed upwards behind the connecting element 7 and through the interior 22 of the fitting housing 1, to be kept lower than in designs in which the plug-in connection 9 is arranged in the same transverse plane as the plug-in connections 8 or closer towards the interior 22 of the fitting housing 1 than the plug-in connections 8.

When the connecting element is inserted, the plate element 10 contacts a shoulder 19 of the receptacle provided at that end of the housing section facing the interior of the fitting housing 1. This is shown in FIG. 2. The mixer cartridge 11 is in direct contact with the connecting element 7. The clamping nut 13 is screwed into a female thread of the housing section 3 and forces the mixer cartridge 11 against the plate element 10 of the connecting element 7. The lines 4, 5 are inserted with their plug-in nipples 20 in that part of the connecting element 7 projecting into an interior 22 of the fitting housing 1. The part of the connecting element 7 projecting into the interior 22 of the fitting housing 1 leaves sufficient space relative to the opposite wall of the interior 22 that the line 5 can be passed through it.

In the embodiment shown in FIG. 1 and FIG. 2, a longitudinal axis of the housing section 3 forming the branch is vertical to the indicated longitudinal axis 21 of the fitting housing 1. In the embodiment now shown in the following figures, the longitudinal axis of the housing section 22 forming the branch is oblique relative to the longitudinal axis 21 of the fitting housing 1. The result of this is that a different connecting element 27 is used. This is shown in FIG. 3 and FIG. 4. The part of the connecting element 27 projecting into the interior 22 of the fitting housing 1 has in turn plug-in connections for the lines 4, 5, as shown in the example in FIGS. 1 and 2. Its plate element 30 is now at an angle relative to the longitudinal axis 21 of the fitting housing 1 such that the surface it forms is in a plane vertical to the longitudinal axis of the housing section 23 forming the branch. The oblique angle is preferably between 45° and 90°, more preferably between about 65° and about 85°.

Here too the mixer cartridge 11 directly contacts the plate element 30 of the connecting element 27.

In both embodiments, the connecting element 7 or 27 is of plastic, so that the water passing through the fitting does not come into contact with metal at any point.

In FIG. 3 an alignment aid 24 can be discerned between the connecting element 27 and the mixer cartridge 11 which interacts with openings 25 in the plate element 10 of the connecting element 27.

The connection between the hoses forming the supply lines 4, 5 and the mixer cartridge 11 is achieved by ducts inside the connecting element, of which one duct 26 can be seen in FIG. 4.

Both embodiments show a sanitary fitting having a fitting housing with a basic element in the form of a straight circular cylinder with an open underside. An interior with a straight-line central axis is formed inside the basic element, into which and out of which lines pass through the open underside. The basic element has a branch which likewise has the form of a circular cylinder with an open outer face. The interior of the branch merges into the interior of the basic element. The branch contains a receptacle for a mixer cartridge. A connecting element inserted in the branch is used to make the water-carrying connection between the lines inside the basic element and the mixer cartridge inside the branch. The connecting element consists of plastic.

What is claimed is:

1. A sanitary fitting, comprising:
a fitting housing with an interior open on at least one side of the fitting housing for insertion of supply lines to the fitting through an open end and a housing section leading into the interior with a receptacle open to an outside for a mixer cartridge and with an opening to the interior; and,
a connecting element, which is insertable into the fitting housing through the opening of the housing section having the receptacle, wherein the connecting element projects with a connecting section into the interior of the fitting housing and makes a connection between at least one of the supply lines and a discharge line, and the mixer cartridge, using ducts.

2. The sanitary fitting according to claim 1, wherein the connecting element contacts with one shoulder of the connecting element, a shoulder of the housing section containing the receptacle.

3. The sanitary fitting according to claim 2, wherein the shoulder is provided on an end of the connecting element associated with the mixer cartridge.

4. The sanitary fitting according to claim 1, wherein the connecting element forms a housing bottom for the mixer cartridge.

5. The sanitary fitting according to claim 1, wherein the housing section having the receptacle forms a branch of the fitting housing.

6. The sanitary fitting according to claim 5, wherein the branch is at right angles to a longitudinal axis of the fitting housing.

7. The sanitary fitting according to claim 5, wherein the branch is oblique to a longitudinal axis of the fitting housing.

8. The sanitary fitting according to claim 1, wherein a separation surface of the connecting element associated with the mixer cartridge is parallel to a longitudinal axis of the fitting housing.

9. The sanitary fitting according to claim 1, wherein a separation surface of the connecting element associated with the mixer cartridge is oblique to a longitudinal axis of the fitting housing.

10. The sanitary fitting according to claim 1, wherein the connecting element has a connecting section with plug-in couplings for at least one of supply lines and discharging lines designed as hoses.

11. The sanitary fitting according to claim 1, wherein a section of the connecting element projects into the interior of the fitting housing leaving free a space for a line to pass the connecting element.

12. The sanitary fitting according to claim 1, further comprising an alignment aid engaging between the fitting housing and the connecting element.

13. The sanitary fitting according to claim 1, further comprising an alignment aid engaging between the connecting element and the mixer cartridge.

14. The sanitary fitting according to claim 1, wherein the connecting element comprises an approved material where the connecting element contacts drinking water.

15. The sanitary fitting according claim 10, wherein the plug-in coupling of the connecting element includes plug-in couplings for the supply and discharging lines, and wherein the plug-in coupling for a discharging line is arranged closer to the mixer cartridge than the plug-in couplings for the supply lines.

16. The sanitary fitting according to claim 14, wherein the approved material comprises plastic.
